(19) United States
(12) Patent Application Publication
(10) Pub. No.: US 2003/0064712 A1
(43) Pub. Date: Apr. 3, 2003

(54) Interactive real world event system via computer networks

(76) Inventors: Jason Gaston, Hillsboro, OR (US); Marshall Gunter, Beaverton, OR (US); Christopher Hall, Portland, OR (US); Liz Taylor, Hillsboro, OR (US); Dan Scott, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/967,685

(22) Filed: Sep. 28, 2001

(51) Int. Cl. H04M 3/42

(52) U.S. Cl. 455/414; 455/422; 455/41

(57) ABSTRACT

A communication module exchanges real-world information with a server in a network via wireless connectivity. The communication module has at least one of a short-range and a long-range communication device operating in at least one of an indoor and an outdoor environment in real-world interactive event.

### BACKGROUND

1. Field of the Invention

This invention relates to real-world systems. In particular, the invention relates to real-world systems via computer networks.

2. Description of Related Art

There is currently an increasing need for community activities that involve many users or participants. One such example is the massively multi-player role-playing game such as the Ultima Online, Asheron's Call and EverQuest. In these games, the player co-inhabit in a virtual world with hundreds of thousands of other people simultaneously. However, these games merely provide a virtual world where the players merely interact with the computer simulating their movements and actions.

Three-dimensional information may be provided by virtual reality (VR) technology. A VR environment typically provides the participants or users an impression of interacting with a real world scenes through computer simulations and interfacing devices. However, VR has been mainly used within a confined area and with applications limited to human versus computer.

Therefore, there is a need to have an efficient technique to provide real-world interactions.

### BRIEF DESCRIPTION OF THE DRAWINGS

The features and advantages of the present invention will become apparent from the following detailed description of the present invention in which:

FIG. 1 is a diagram illustrating a system in which one embodiment of the invention can be practiced.

FIG. 2 is a diagram illustrating a real-world processing unit shown in FIG. 1 according to one embodiment of the invention.

FIG. 3 is a diagram illustrating a real-world interactive event management system shown in FIG. 1 according to one embodiment of the invention.

FIG. 4 is a flowchart illustrating a process in a real-world interactive event according to one embodiment of the invention.

### DESCRIPTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

The present invention may be implemented by hardware, software, firmware, microcode, or any combination thereof. When implemented in software, firmware, or microcode, the elements of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

It is noted that the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

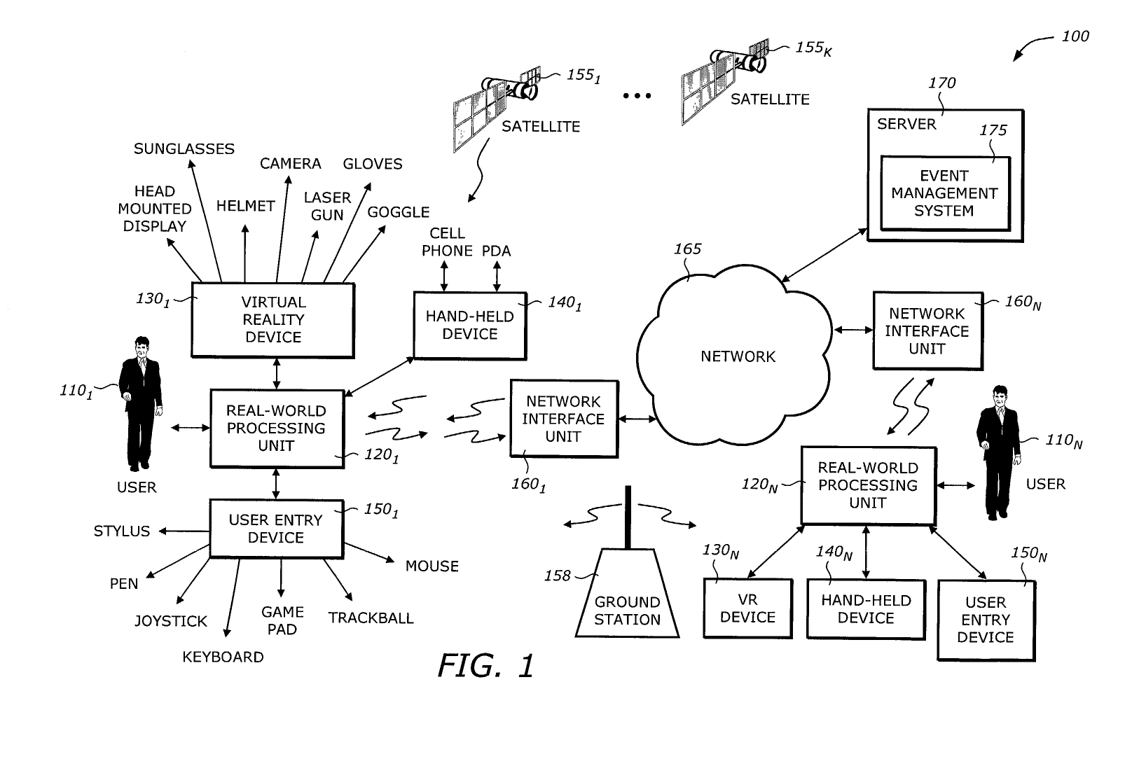

FIG. 1 is a diagram illustrating a system 100 in which one embodiment of the invention can be practiced. The system 100 includes a user 110 ₁, a real-world processing unit 120₁, a virtual reality (VR) device 130₁, a hand-held device 140₁, a user entry device 150₁, satellites 155₁ to 155_{K}, a ground station 158, a network interface unit 160₁, a network 165, a central server 170, a user 110_{N}, a real-world processing unit 120_{N}, a virtual reality (VR) device 130_{N}, a hand-held device 140_{N}, and a user entry device 150_{N}.

Users 110₁ and 110_{N} are users participating in a real-world interactive event (RWIE). For clarity, the subscripts are dropped in the following description. The RWIE may involve only a single user or multiple users. The RWIE is an event or activity that allows the participating user to interact with other participants or with the central server 170 via exchanging real-world information. Examples of the RWIE include massively multi-player role-playing game, an advertising session, a guided tour, a promotional activity, a virtual meeting, an information exchange, and a broadcast session. The real-world information includes data or information having real-world characteristics. Real-world characteristics here include three-dimensional location coordinates, real-time data, sensed data of physical conditions, etc. The real-world information may be an environmental condition, a location indicator, a time indicator, a user entry, a display message, a user information, an event information, and a status indicator, or any other information relevant to the event. The environmental condition may be temperature, humidity, biological conditions of the user (e.g., heart beat, energy level), images, etc. The location indicator indicates the location of the user or any other reference object (e.g., building, room, computer). The time indicator indicates time information (e.g., elapsed time, real-time clock), the user entry may include voice, data, image, entry input via the user entry device 150. The display message may be an image encoded in an appropriate compressed format. The user information may include information about the user such as background data (e.g., name, age, membership), historical information (e.g., frequency of usage), status level in the event (e.g., ranking, standing). The event information may include information about the event or related events (e.g., promotional data, number of participants, current locations of participants). The status indicator may include any status conditions relevant to the event or the user (e.g., inactive, active, idle, busy) or the status of the event (e.g., meeting is adjourned, game is at the final stage). The real-world information may be exchanged between the user and the central server 170 or between users or between a user and an external communication system.

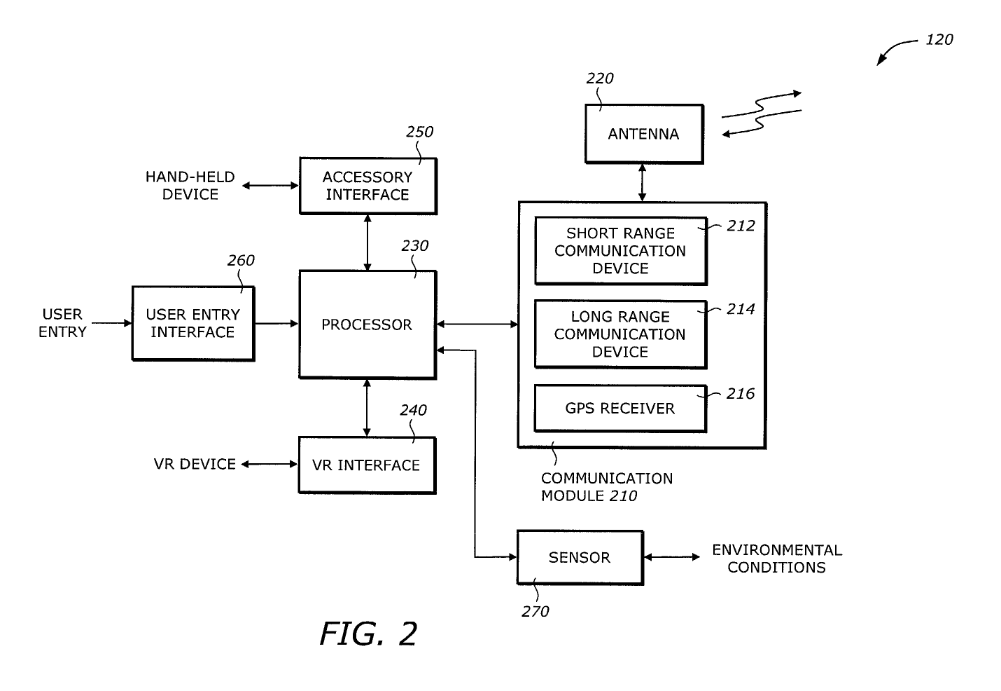

The real-world processing unit 120 is a module attached to the user 110 either directly or indirectly via the hand-held device 140. The real-world processing unit 120 allows the user 110 to participate in the RWIE. The real-world processing unit 120 has communication ability to send and receive real-world information to other users or to the central server 170. The real-world processing unit 120 will be described later in FIG. 2.

The VR device 130 is any VR device used by the user 110 to interact with the environment, other users, or the central server 170 in a VR scenario. The VR device 130 may be any suitable device that provides sensing, interactions, imputs, outputs, and other interfaces such as a head-mounted display, a headset, a helmet, a goggle, sunglasses, a glove, a camera, a laser gun, and a proximity sensor. The user 110 may review the real-time real-world information sent from the central server 170 using the head-mounted display, the goggles, or the sunglasses. The glove may be used to transmit the user hand movements to the central server 170. The laser gun is one example of an equipment or instrument used by the user in the event. For example, in a massively multi-player role-playing game, the laser gun may be used by the user to tag on other users.

The hand-held device 140 is any suitable hand-held device used by the user 110. The hand-held device 140 may be a portable unit with proper interface for communication such as a cellular phone, a mobile unit, a personal digital assistant (PDA), or a mobile game box. The hand-held device 140 provides additional capability to the real-world processing unit 120 such as wireless connectivity via cellular phone, transmission of voice information, computing power, synchronization with other events via the PDA. The user 110 may use the real-world processing unit 120 as a stand-alone unit or as an add-on module attached to the hand-held device 140.

The user entry device 150 is any device that allows the user 110 to enter data or information. The user entry device 150 may be a game pad, a joystick, a keyboard, a trackball, a mouse, a pen, a stylus, etc. The user entry device 150 may be connected to the real-world processing unit 120, the hand-held device 140, or both.

Satellites 155₁ to 155_{K} provide communication data to the user 110 such as Global Positioning System (GPS) data, broadcast information, etc. The ground station 158 provides additional or supplemental communication data such as land-based differential signals to the user 110.

The network interface unit 160 is a unit having ability to connect to the network 165. The network interface unit 160 may be a network interface card in a personal computer (PC), a short-range interface device (e.g., Bluetooth, infrared receiver). The network 165 is any network that is used by the RWIE. The network 165 may be the Internet, a local area network (LAN), a wide area network (WAN), an extranet, an intranet. The central server 170 is a server connected to the network 165. The central server 170 includes a event management system 175. The event management system 175 manages and coordinates the RWIE. The network interface unit 160 forwards the real-time information from the users to the central server 170 via the network 165. The central server 170 processes the real-time information and send back responses or other real-time information to the network interface unit 160 to be forwarded to the users.

FIG. 2 is a diagram illustrating the real-world processing unit 120 shown in FIG. 1 according to one embodiment of the invention. The real-world processing unit 120 includes a communication module 210, an antenna 220, a processor 230, a VR interface 240, and an accessory interface 250. As is known by one skilled in the art, the real-world processing unit 120 may not include all of these elements and one or more elements may be optional.

The communication module 210 sends or receives real-world information to or from other users or the central server 170. The communication module 210 has a short-range communication device 212, or a long-range communication device 214, or both. The communication devices 212 and 214 may operate in an indoor or outdoor environment. Short-range communication devices include devices that operate within a short range (e.g., less than 100 meters). Examples of short-range communication devices are short-range radio frequency (RF) devices; Bluetooth devices; wireless devices such as those following the American National Standards Institute (ANSI)/Institute of Electrical and Electrical Engineers (IEEE) standard 802.11 as published in the document titled, “Part II, Wireless LAN Medium Access Control (MAC) and Physical Layer (PHY) Specification”, 1999 Edition; infrared receiver/transmitter; infrared beacons; and ultrasonic receiver/transmitter. Examples of long-range communication devices are long-range RF devices. The communication module 210 may also include a GPS receiver 216 to receive GPS positional data via GPS satellites. The GPS receiver 216 may not detect satellite transmissions indoors. Hand-off from outdoor communication devices to indoor communication devices or vice versa can be made on a real-time basis according to the location of the user that carries the communication module 210 or the quality of the signals.

The antenna 220 receives and transmits electromagnetic signals carrying real-world information to and from the communication module 210. The antenna 220 is used for long-range and short-range RF communication devices. The antenna 220 may be already available in the hand-held device 140 (e.g., cellular phone or mobile unit) or may be a second antenna to receive GPS data.

The processor 230 is a processing element that processes the real-world information received or to be transmitted by the communication module 210. The processor 230 represents a central processing unit of any type of architecture, such as embedded processors, micro-controllers, graphics processors, digital signal processors, superscalar computers, vector processors, single instruction multiple data (SIMD) computers, complex instruction set computers (CISC), reduced instruction set computers (RISC), very long instruction word (VLIW), or hybrid architecture. The processor 230 preferably operates in a low-power mode. The processor 230 includes memory to provide program and data storage, input/output devices such as communication interfaces, interrupt controllers, timers, etc., and any other peripheral devices. The processor 230 may include a mass storage device such as compact disk read-only memory (CD-ROM), floppy diskette, diskette cartridge, etc. The processor 230 receives user entry via the user entry device 150.

The VR interface 240 provides interface to the appropriate VR device 130. For example, image data received from the central server 170 may be transmitted to the head-mounted display. The accessory interface 250 provides interface to the hand-held device 140. For example, the user profiles or the event information may be displayed on the PDA display. The user entry interface 260 provides an interface to the user entry device 150. The user entry interface 250 may also share with the accessory interface 250 so that existing user entry on the hand-held device 140 can be used to enter user entry. The sensor 270 senses the environmental conditions such as temperature, biological conditions of the user (e.g., heart beat, energy level), locomotive ability of user.

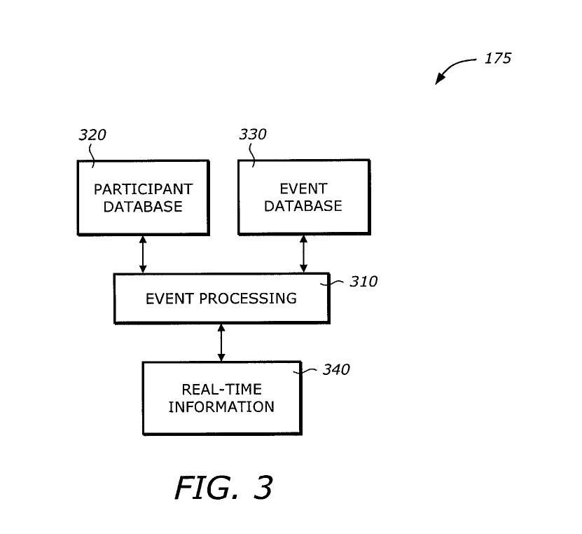

FIG. 3 is a diagram illustrating the real-world interactive event management system 175 shown in FIG. 1 according to one embodiment of the invention. The real-world interactive event management system 175 includes an event processing module 310, a participant database 320, an event database 330, and a real-time event information 340.

The event processing module 310 processes the information as received from the real-time event information 340 and transmits the information to the participants. The information may include a request for participating in the event, a request for withdrawing from the event, the location data of the participants, the records of the participants, the image data of relevant objects, etc. The event processing module 310 may performs any task necessary for the event. For example, when the event is a massively multi-player role-playing game, the event processing module 310 may create a map of players or participants in the community of the players, maintain the interactions, keep track of movements and dialogs, update the participant database 320, sending the images of the characters of the players, etc. When the event is a guided tour, the event processing module 310 may retrieve the information on a particular place near the users based on their real-time location information. When the event is a real-world promotional activity or advertisement, the event processing module 310 may retrieve slogans, promotional offers, or messages of nearby establishments and send to the participant based on the participant real-time location.

The participant database 320 contains records or data of participants in the event. The event participants may be active or inactive at the time of the current event. The participant database 320 may be constantly updated by the event processing module 310 as appropriate. In a massively multi-player role-playing game, the participant database 320 may include player's profile such as age, name, nickname, character name(s), experience level, skill level, play record, and role characteristics (e.g., appearance, gender, skin tone, hairstyle, clothing, weapons, equipment, occupation, social status, race, class, strength level, intelligence level). In a guided tour or pop-up advertisement, the participant database 320 may include participant's preferences and interests, demographic profile, income level, investment objectives.

The event database 330 contains records or data about the event. The event data may include rules of the event (e.g., rules of game, meeting, or activity), promotional information, links to other Web sites, contents (e.g., text, image, hyperlinks).

The real-time information 340 includes real-time data transmitted from the participants or sent by the event processing module 310. The participants may transmit their location, requests, user entries, environmental conditions, status indicator, etc. The event processing module 310 may send display messages, participant profiles, event status, responses to requests, participant locations, promotional messages, etc. The real-time information 340 may include real-time location map of all participants.

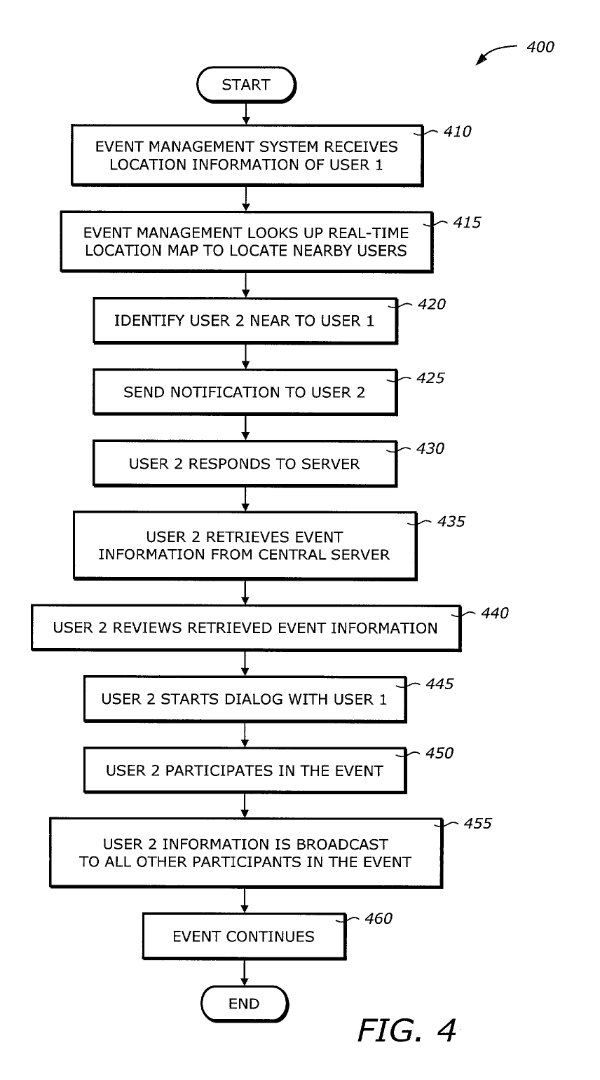

FIG. 4 is a flowchart illustrating a real-world interactive event 400 according to one embodiment of the invention. In the description that follows, the process 400 is based on the massively multi-player role-playing game. As is known by one skilled in the art, the process 400 may be extended or modified for other events.

Upon START, the event management system receives location information from user 1 (Block 410). The location information may be transmitted by user 1 continuously, periodically, or upon activation by user 1 or inquiry by the event management system. Next, the event management system looks up the real-time location map as created by the event processing module 310 (FIG. 3) to locate nearby users (Block 415). The real-time location map may also include a tag or indicator associated with each user to indicate if the user is active or interested in participating in the game at the time. Then, the event management system identifies one or more interested and active nearby users (Block 420). Next, the event management system sends a notification to user 2 who is located nearby, active, and is interested in participating (Block 425).

Upon receiving the notification from the event management system, user 2 responds to the central server (Block 430). Then, user 2 retrieves the event information from the central server (Block 435). The event information may include the real-time real-world location of other users or players, the current status of the game, or any other relevant information. Next, user 2 reviews the retrieved event information using the real-world processing unit 120 (FIG. 1) and/or any of the components of the associated devices such as the head-mount display, the hand-held device, etc. (Block 440).

After reviewing the event information, user 2 starts a dialog with user 1 if necessary (Block 445). The dialog may be conducted directly between the two users via the cell phone or the mobile unit, or indirectly via the central server 170. User 2 may also request a dialog with another user not nearby. Next, user 2 participates in the event (Block 450). For example, user 2 may hunt down user 1 or another user and use the laser gun to tag the other user. Then, the real-time information of user 2 including his or her real-time real-world location, environmental conditions, etc. is updated in the event management system and may be broadcast to other users participating in the event (Block 455). The event then continues until terminated by some terminating condition (Block 460).

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. An apparatus comprising:
a communication module to exchange real-world information with a server in a network via wireless connectivity, the communication module having at least one of a short-range and a long-range communication device operating in at least one of an indoor and an outdoor environment in a real-world interactive event.

2. The apparatus of claim 1 wherein the real-world information includes at least one of an environmental condition, a location indicator, a time indicator, a user entry, a display message, a user information, an event information, and a status indicator.

3. The apparatus of claim 1 wherein the short-range communication device is one of a short-range radio frequency (RF) device, an infrared device, a proximity device, and an ultrasonic device.

4. The apparatus of claim 1 wherein the long-range communication device is one of a long-range radio frequency (RF) device, a Global Positioning System (GPS) receiver.

5. The apparatus of claim 4 wherein short-range RF device is one of a Bluetooth device and an 802.11 radio device.

6. The apparatus of claim 1 further comprising:
a processor coupled to the communication module to process the real-world information for use in the real-world interactive event.

7. The apparatus of claim 1 further comprising:
a sensor to sense the environmental condition, the sensed environmental condition being transmitted to the server via the communication module.

8. The apparatus of claim 6 further comprising:
a virtual reality (VR) interface module coupled to the processor to provide interface to a VR device.

9. The apparatus of claim 7 wherein the VR device is one of a head-mounted display, a headset, a helmet, a goggle, sunglasses, a glove, a camera, a laser gun, and a proximity sensor.

10. The apparatus of claim 1 further comprising:
an accessory interface to interface to a hand-held device.

11. The apparatus of claim 9 wherein the hand-held device is one of a cellular unit, a mobile unit, and a personal digital assistant (PDA).

12. The apparatus of claim 1 further comprising:
a user entry interface to interface to a user entry device to allow a user of the communication module to enter the user entry.

13. The apparatus of claim 1 wherein the real-world interactive event is one of a massively multi-player role-playing game, an advertising session, a guided tour, a promotional activity, a virtual meeting, an information exchange, and a broadcast session.

14. A method comprising:
exchanging real-world information with a server in a network via wireless connectivity using a communication module having at least one of a short-range and a long-range communication device operating in at least one of an indoor and an outdoor environment in a real-world interactive event.

15. The method of claim 14 wherein the real-world information includes at least one of an environmental condition, a location indicator, a time indicator, a user entry, a display message, a user information, an event information, and a status indicator.

16. The method of claim 14 wherein the short-range communication device is one of a short-range radio frequency (RF) device, an infrared device, a proximity device, and an ultrasonic device.

17. The method of claim 14 wherein the long-range communication device is one of a long-range radio frequency (RF) device, a Global Positioning System (GPS) receiver.

18. The method of claim 18 wherein short-range RF device is one of a Bluetooth device and an 802.11 radio device.

19. The method of claim 14 further comprising:
processing the real-world information for use in the real-world interactive event.

20. The method of claim 14 further comprising:
sensing the environmental condition, the sensed environmental condition being transmitted to the server via the communication module.

21. The method of claim 14 further comprising:
providing interface to a VR device.

22. The method of claim 21 wherein the VR device is one of a head-mounted display, a headset, a helmet, a goggle, sunglasses, a glove, a camera, a laser gun, and a proximity sensor.

23. The method of claim 14 further comprising:
interfacing to a hand-held device.

24. The method of claim 23 wherein the hand-held device is one of a cellular unit, a mobile unit, and a personal digital assistant (PDA).

25. The method of claim 14 further comprising:
interfacing to a user entry device to allow a user of the communication module to enter the user entry.

26. The method of claim 14 wherein the real-world interactive event is one of a massively multi-player role-playing game, an advertising session, a guided tour, a promotional activity, a virtual meeting, an information exchange, and a broadcast session.

27. A system comprising:
a user entry device used by a user; and
a real-world processing unit coupled to the user entry device, the real-world processing unit comprising;
a communication module to exchange real-world information with a server in a network via wireless connectivity, the communication module having at least one of a short-range and a long-range communication device operating in at least one of an indoor and an outdoor environment in a real-world interactive event.

28. The system of claim 27 wherein the real-world information includes at least one of an environmental condition, a location indicator, a time indicator, a user entry, a display message, a user information, an event information, and a status indicator.

29. The system of claim 27 wherein the short-range communication device is one of a short-range radio frequency (RF) device, an infrared device, a proximity device, and an ultrasonic device.

30. The system of claim 27 wherein the long-range communication device is one of a long-range radio frequency (RF) device, a Global Positioning System (GPS) receiver.

31. The system of claim 30 wherein short-range RF device is one of a Bluetooth device and an 802.11 radio device.

32. The system of claim 27 wherein the real-world processing unit further comprises:
a processor coupled to the communication module to process the real-world information for use in the real-world interactive event.

33. The system of claim 27 wherein the real-world processing unit further comprises:
a sensor to sense the environmental condition, the sensed environmental condition being transmitted to the server via the communication module.

34. The system of claim 32 wherein the real-world processing unit further comprises:
a virtual reality (VR) interface module coupled to the processor to provide interface to a VR device.

35. The system of claim 27 wherein the VR device is one of a head-mounted display, a headset, a helmet, a goggle, sunglasses, a glove, a camera, a laser gun, and a proximity sensor.

36. The system of claim 27 wherein the real-world processing unit further comprises:
an accessory interface to interface to a hand-held device.

37. The system of claim 36 wherein the hand-held device is one of a cellular unit, a mobile unit, and a personal digital assistant (PDA).

38. The system of claim 27 wherein the real-world processing unit further comprises:
a user entry interface to interface to the user entry device to allow a user to enter the user entry.

39. The system of claim 27 wherein the real-world interactive event is one of a massively multi-player role-playing game, an advertising session, a guided tour, a promotional activity, a virtual meeting, an information exchange, and a broadcast session.
